(19) United States
(12) Patent Application Publication
(10) Pub. No.: US 2012/0186926 A1
(43) Pub. Date: Jul. 26, 2012

(54) HANDLE-SCALE FOR SUITCASE

(75) Inventor: Haroon Sheikh, Miami, FL (US)

(73) Assignee: HEYS (USA), INC., Weston, FL (US)

(21) Appl. No.: 13/358,925

(22) Filed: Jan. 26, 2012

Related U.S. Application Data
(60) Provisional application No. 61/436,427, filed on Jan. 26, 2011.

(51) Int. Cl. A45C 13/28; G01G 19/58; A45C 15/00

(52) U.S. Cl. 190/115; 177/132

(57) ABSTRACT

A handle-scale includes a luggage-scale for calculating a weight of a piece of luggage that is built into a carry-handle having weight-release slides and/or metal hinges. Scale functionality may be enclosed within the carry-handle. The luggage-scale may have a digital readout display, such as a touch screen, that changes color once weight is calculated. The handle-scale may be movable between a first and a second vertical position with respect to the piece of luggage during use. The handle-scale may include an outer shell that protects the digital readout by withdrawing the digital readout from an exterior of the handle-scale such that when a user grips the handle, the hand of the user does not touch the digital readout. The handle-scale may separately display a measurement scale, and whole and partial units of the calculated weight. The handle-scale may have an undulating outer exterior to facilitate gripping and manually lifting.

### CROSS-REFERENCE TO RELATED APPLICATION

This patent application claims priority to U.S. Provisional Application having Ser. No. 61/436,427 filed Jan. 26, 2011, which is incorporated herein by reference in its entirety.

### FIELD OF THE INVENTION

The present application relates to luggage, and more particularly to devices for weighing luggage.

### BACKGROUND

Conventional luggage scales include: U.S. Pat. No. 2,710,083 (discloses a “Weighing Device For Luggage”); U.S. Pat. No. 3,090,454 (discloses a “Scale Luggage Handle”); and WO 03/100360 (discloses “Weighing Devices” for luggage). However, conventional luggage scales may have various drawbacks, such as being awkward during use and/or un-ergonomical.

### SUMMARY

A luggage-scale may be built into a carry-handle having traditional weight-release slides. All of the scale functionality may be enclosed within the carry-handle, and not built into the outer or packing shell of the case of a suitcase or other piece of luggage. The luggage-scale may have a digital display screen that changes color once the weight of the suitcase has been calculated during use. The luggage-scale may give aural and/or visual indications that the weight of the suitcase has been calculated. The luggage-scale may include a fully functioning touch screen device.

In one aspect, a handle-scale for calculating a weight of a suitcase may be provided. The handle-scale may include a hard outer shell configured as a carry-handle of the suitcase. The handle-scale and/or carry-handle may have weight-release slides and/or metal hinges on the left and right ends of the handle-scale and/or carry-handle, respectively, attaching the handle-scale and/or carry-handle to the suitcase. Scale functionally may be enclosed within the hard outer shell configured as the carry-handle. The scale functionally may be configured to calculate a weight of the suitcase when manually lifted by the carry-handle. The handle-scale may include a digital display embedded within the carry-handle that is configured to display a calculated weight of the suitcase. The digital display may be configured to provide a visual or aural indication that the weight of the suitcase has been calculated when the suitcase has been manually lifted by the carry-handle during use.

In another aspect, a handle-scale for calculating a weight of a suitcase may be provided. The handle-scale may be configured to manually lift the suitcase and be movable between a first vertical position and a second vertical position with respect to the suitcase during use. The first vertical position may be a relaxed position of the handle-scale for when the handle-scale is not weighing the suitcase, and the second vertical position may be a weighing position of the handle-scale for when the handle-scale is supporting and weighing the suitcase. A processor or electronic scale may be embedded within the handle-scale that is configured to calculate a weight of the suitcase when the suitcase is manually lifted via the handle-scale. The handle-scale may move vertically from the first vertical position to the second vertical position during use and when the handle-scale supports the suitcase vertically. The handle-scale may automatically return vertically to the first vertical position when the suitcase is set back down. The handle-scale may further include a digital readout display on an outward face for displaying a digital readout of the calculated weight of the suitcase that is calculated when the suitcase is manually lifted and weighed.

Additionally, a piece of luggage, such as a hard-sided suitcase, a soft-sided suitcase, or other hard and soft travel goods, may include a handle-scale that provides a digital readout of the weight of the piece of luggage when manually lifted by the handle-scale. The handle-scale may be movable between a first and a second vertical position with respect to the piece of luggage during use. A digital readout display on the handle-scale may display a digital readout of the calculated weight of the piece of luggage. The handle-scale may include an outer shell that protects the digital readout by withdrawing the digital readout from an exterior of the handle-scale such that when a user grips the handle, the user's hand or palm does not touch or substantially touch the digital readout. The handle-scale may separately display a measurement scale, and whole and partial units of the calculated weight within the measurement scale. The handle-scale may have an undulating outer exterior to facilitate gripping the handle-scale and manually lifting of the piece of luggage via the handle-scale.

In one aspect, a hard-shell suitcase having a handle-scale may be provided. The hard-shell suitcase may include a bottom hard-shell; a zipper assembly interconnected with the bottom hard-shell; and a top hard-shell interconnected with the zipper assembly such that the top hard-shell may be opened up from the bottom hard-shell by operation of the zipper assembly. The hard-sided suitcase may include a left mount and a right mount affixed to the top hard-shell. The handle-scale may have a left end and a right end, the left end may be permanently or removably interconnected with the left mount and the right end may be permanently or removably interconnected with the right mount such that the hard-shell suitcase may be manually lifted via the handle-scale. The handle-scale may be configured to move vertically between a relaxed position during non-use and a weighing position during use. A processor or electronic scale may be embedded within the handle-scale that is configured to calculate a weight of the hard-shell suitcase when the hard-shell suitcase is manually lifted via the handle-scale, moving the handle-scale vertically to the weighing position. A digital readout display on an outward face of the handle-scale may display a digital readout of the calculated weight of the hard-shell suitcase.

In another aspect, a piece of luggage, such as a hard-sided suitcase, a soft-sided suitcase, or other hard and soft travel goods, having a handle-scale may be provided. The piece of luggage may have a bottom shell; a top shell; and a zipper assembly interconnected with the bottom shell and the top shell such that the piece of luggage is configured to be opened via manual operation of a zipper interconnected with the zipper assembly. The piece of luggage may include a handle-scale interconnected with the piece of luggage such that the hard-shell suitcase may be manually lifted via the handle-scale. The handle-scale may be movable vertically between a relaxed position and a weighing position with respect to the piece of luggage. The handle-scale may be configured to automatically revert to the relaxed position during non-use, and move vertically to the weighing position when the handle-scale is being used to manually lift the piece of luggage. The handle-scale may include a processor or electronic scale embedded within the handle-scale that is configured to calculate a weight of the piece of luggage when the piece of luggage is manually lifted via the handle-scale, which moves the handle-scale vertically to the weighing position; and a digital readout display on an outward face of the handle-scale for displaying a digital readout of the calculated weight of the piece of luggage that is calculated by the processor or electronic scale when the suitcase is manually lifted and weighed.

Advantages of the present invention will become more apparent to those skilled in the art from the following description of the preferred embodiments which have been shown and described by way of illustration. As will be realized, the invention is capable of other and different embodiments, and its details are capable of modification in various respects. Accordingly, the drawings and description are illustrative in nature and not restrictive.

### BRIEF DESCRIPTION OF THE DRAWINGS

There are shown in the drawings arrangements which are presently discussed, it being understood, however, that the invention is not limited to the precise arrangements and instrumentalities shown, wherein:

FIG. 1 depicts an exemplary handle-scale in a relaxed or first vertical position;

FIG. 2 depicts another view of the exemplary handle-scale in the relaxed or first vertical position;

FIG. 3 depicts a view of the exemplary handle-scale in a weighing or second vertical position; and

FIG. 4 depicts a method of calculating the weight of a suitcase using the handle-scale.

### DETAILED DESCRIPTION OF THE INVENTION

The exemplary embodiments include a luggage-scale that may be built into a carry-handle having weight-release slides and/or metal hinges on the left and the right ends. All of the scale functionality may be enclosed within the carry-handle, and not built into the outer or packing shell of the case of a suitcase or other piece of luggage. For instance, the carry-handle may include a hard outer shell. The luggage-scale may be enclosed within the hard outer shell defining the carry-handle. The luggage-scale may include a processor, electronic scale, or other electrical or mechanical means for calculating weight.

The luggage-scale may have a digital display screen that changes color or provides another visual indication once the weight of the suitcase has been calculated during use. Alternatively or additionally, an aural indication may be provided once the weight of the suitcase has been calculated during use. For instance, the luggage-scale may include one or more speakers. After the weight of the suitcase has been calculated, the luggage-scale may beep, or aurally provide the weight calculated.

The luggage-scale may be turned on and off via a button or on/off switch. Additionally or alternatively, the luggage-scale may include a fully functioning touch screen device. The luggage-scale may be turned on and off via the touch screen. The touch screen may be used to illuminate the display, change the measurement units in which calculated weight is displayed, change the background color of the display, change a sound level of aural indications, and/or change other functionality.

The exemplary embodiments of the present disclosure are described with respect to a hard-sided suitcase for carrying and/or storing different types of articles. It should be understood by one of ordinary skill in the art that the exemplary embodiments of the present disclosure may be applied to other types of hard-sided suitcases and/or other types of luggage. Referring to the drawings, an embodiment of a hard-sided suitcase 100 for storing articles is illustrated. Notably, the suitcase may comprise a variety of different types of luggage. For example, the suitcase may be a traditional suitcase, a briefcase, a laptop bag/case, a computer bag/case, a business case, a travel bag, a beauty case, or a variety of other types of luggage, including hard-sided and soft-sided travel goods. Of course, the aforementioned types of suitcases are merely for illustrative purposes and are not intended to limit the suitcase to the listed varieties.

In one aspect, a hard-shell suitcase having a handle-scale may be provided. The hard-shell suitcase may include a bottom hard-shell; a zipper assembly interconnected with the bottom hard-shell; and a top hard-shell interconnected with the zipper assembly such that the top hard-shell may be opened up from the bottom hard-shell by operation of the zipper assembly. The hard-sided suitcase may include a left mount and a right mount affixed to the top hard-shell. The handle-scale may have a left end and a right end, the left end may be permanently interconnected or removably detachable with the left mount and the right end may be permanently interconnected or removably detachable with the right mount such that the hard-shell suitcase may be manually lifted via the handle-scale. The handle-scale may be configured to vertically move between a relaxed position during non-use and a weighing position during use. A processor or electronic scale may be embedded within the handle-scale configured to calculate a weight of the hard-shell suitcase when the hard-shell suitcase is manually lifted via the handle-scale. A digital readout display on an outward face of the handle-scale may display a digital readout of the calculated weight of the hard-shell suitcase that is calculated when the suitcase is manually lifted via the handle-scale.

The handle-scale may be battery operated and include an on/off switch configured to turn the handle-scale on and off. The handle-scale may include an outer shell configured to protect the digital readout by withdrawing the digital readout from an exterior of the handle-scale such that when a user grips the handle, the user does not touch or exert much force or pressure, if any, upon the face of the digital readout with his or her palm. The outer shell may have an undulating outer exterior to facilitate ergonomically gripping the handle-scale and manually lifting of the hard-shell suitcase via the handle-scale. The outer shell may be configured to separately display a measurement scale and a weight amount of the calculated weight of the hard-shell suitcase in the measurement scale,

In another aspect, a handle-scale for calculating a weight of a piece of luggage, such as a hard-sided or soft-sided travel good, a suitcase, a bag, or other items of luggage mentioned herein, may be provided. The handle-scale may be configured to manually lift the piece of luggage and be vertically movable between a first vertical position and a second vertical position with respect to the piece of luggage during use. The first vertical position may be a relaxed or rest position that the handle-scale is normally in, such as when the handle-scale is not weighing the piece of luggage, and the second vertical position may be a weighing position of the handle-scale that the handle-scale is in when the handle-scale is vertically supporting, i.e., lifting, and weighing the piece of luggage. A processor or electronic scale may be embedded within the handle-scale that is configured to calculate a weight of the piece of luggage when the piece of luggage is manually lifted and vertically supported via the handle-scale and after the handle-scale has vertically moved from the first vertical or relaxed position to the second vertical or weighing position. In the second vertical or weighing position, the processor or electronic scale may calculate a weight from the force exerted upon the first and second ends of the handle-scale by the piece of luggage being lifted. The handle-scale may further include a digital readout display on an outward face for displaying a digital readout of the calculated weight of the piece of luggage that is calculated when the piece of luggage is manually lifted via the handle-scale.

The handle-scale may include an outer shell configured to protect the digital readout(s) by withdrawing the digital readout(s) from an exterior of the handle-scale such that when a user grips the handle, the palm or hand of the user does not touch, substantially touch, or exert pressure or substantial pressure on the face of the digital readout(s). The handle-scale may include an outer shell configured to separately display (1) a measurement scale in which the calculated units are being calculated via the processor or electronic scale, (2) a whole units of the calculated weight within the measurement scale, and (3) a decimal point and a partial units of the calculated weight within the measurement scale.

The handle-scale may be battery operated and include an on/off switch configured to turn the handle-scale on and off. The handle-scale may include an outer shell having an undulating outer exterior to facilitate ergonomically gripping the handle-scale and manually lifting of the piece of luggage via the handle-scale. The handle-scale may have an outer shell or exterior that is manufactured from a hard plastic or polycarbonate composite.

In one embodiment, the handle-scale may comprise a luggage-scale built into a carry-handle of a piece of luggage. The luggage-scale may include weighing components, such as electronic scale and/or processing components, configured to weigh the piece of luggage when lifted by the carry-handle. Alternatively, the weighing components may include other electrical and/or mechanical indications of weight, such as electrical and/or mechanical pressure sensors, springs, latches, bellows, ratchet levers, compression springs, and other weighing components.

The luggage-scale may include and/or be interconnected with a digital display or other readout. The display may be configured to display units and a measurement scale. The display may be configured to change color. The carry-handle may be configured to enclose the luggage-scale, along with the weighing components and digital display. As a result, total scale functionality of the handle-scale may be built into and enclosed by the carry-handle, and not built into the outer shell of the piece of luggage.

The carry-handle may be made from hard plastic material and include weight-release slides or other types of slides at both ends. The carry-handle may be ergonomically designed. The carry-handle may be a single piece of hard material, or have a top flat piece and a bottom piece having an undulating grip portion to accommodate a user's fingers during use.

The weight-release or other types slides may be integrated or otherwise interconnected with the electronic scale and/or processor of the luggage-scale. The weight-release slides may be weight-release clips, such as those typically used for backpacks or scuba gear. Other weight-release slides, as well as other types of slides or hinges, may be used.

A left weight-release slide may be integrated or interconnected with a left mount on the piece of luggage, and a right weight-release slide may be integrated or interconnected with a right mount on the piece of luggage. For instance, each weight-release slide may comprise a male member that snaps into a corresponding female mount on the piece of luggage.

Alternatively or additionally, the weight-release slides may be permanently interconnected with left and right mounts located on the surface of the piece of luggage. The carry-handle may include female ports on the left and right ends for accepting and locking the weight-release slides into place.

In addition to or in lieu of the weight-release slides, the carry-handle and/or left and right mounts located on the piece of luggage, may include metal hinges that facilitate the carry-handle moving from the rest position to the weighing position during use. For example, the weight-release slides may each be interconnected with one or more metal or other hinges that allow the carry-handle to move vertically from a rest position and into a weighing position. The metal hinges may be located in the left and right mounts on the exterior of the piece luggage and/or internally to the carry-handle, such as being integrated with the luggage-scale. The metal hinges may allow the carry-handle to move vertically with respect to the exterior of the piece of luggage by a visibly noticeable amount, such as by 0.1 inches, 0.2 inches, 0.3 inches, 0.5 inches, or other vertical amounts.

During use, once a user lifts up on the carry-handle, the metal hinges may allow the carry-handle to move from the relaxed or normal position, to a weighing position. In other words, the metal hinges may provide the carry-handle vertical flexibility with respect to the exterior of the piece of luggage. The metal hinges may be pulled up on each side of the carry-handle when a user pulls up on the carry-handle.

Once in the weighing position, the luggage-scale may measure the amount of force or pressure being exerted upon the ends of the carry-handle, such as the force or pressure being exerted upon the weight-release slides and/or metal hinges. The force or pressure measured may be converted by the luggage-scale into a calculated weight of the piece of luggage. Once the weight is calculated, the luggage-scale may change the color of the background of the display. The calculated weight may also be displayed on the display. Once the piece of luggage is set back down, the metal hinges may be biased or spring operated to return the carry-handle (and luggage-scale) back to the rest or normal position.

In another embodiment, the carry-handle may be spring loaded. The carry-handle may lock into the vertically raised or weighing position during use. Pushing a button on the carry-handle may allow the carry-handle to be released from the weighing position and returned toward the rest or normal position, such as via a latch or spring return. For instance, a spring may pull the carry-handle back toward the rest position after being released from the weighing position.

### I. Exemplary Handle-Scale

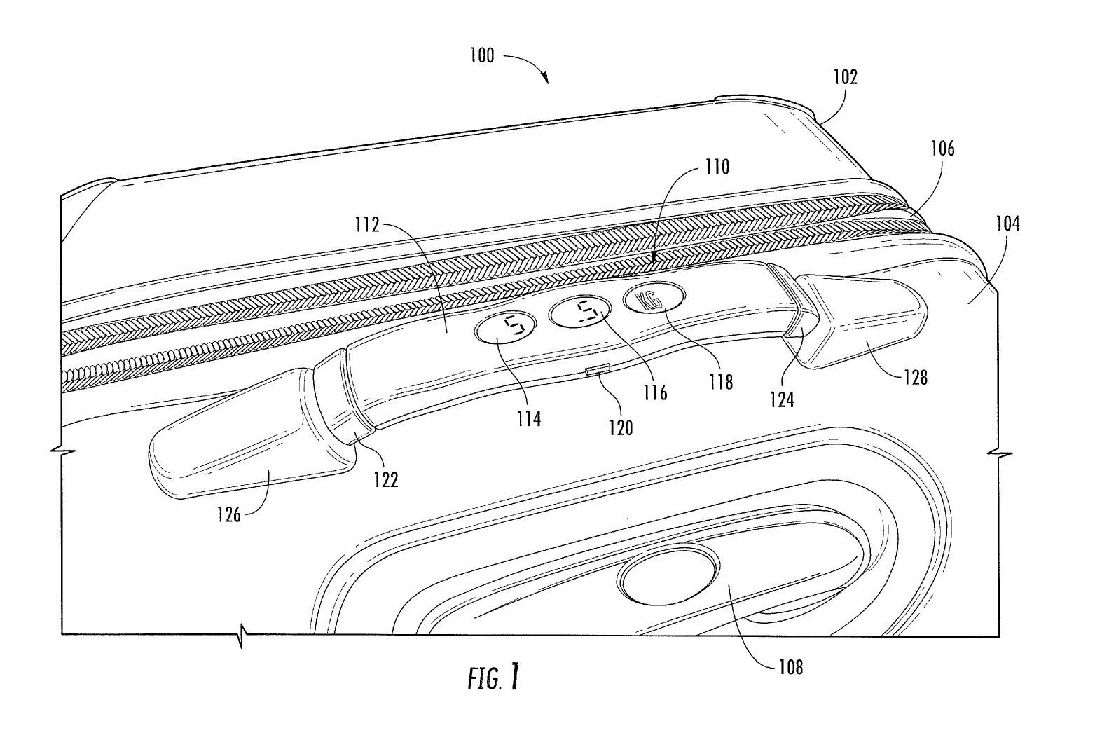

FIG. 1 depicts an exemplary handle-scale 110 in a relaxed or first vertical position. A hard-sided suitcase 100 may be provided having a bottom hard shell 102, a top hard shell 104, and a zipper assembly 106 for interconnecting the bottom hard shell 102 and top hard shell 104, and opening and closing the hard-sided suitcase 100. The hard-sided suitcase 100 may also include a telescoping handle 108 and a handle-scale 110. The hard-sided suitcase may include additional, fewer, or alternate components.

The handle-scale 110 may include a main body 112, a first digital readout 114, a second digital readout 116, a third digital readout 118, an on/off or other type of switch 120, a first end 122 and a second end 124. The handle-scale 110 may include additional, fewer, or alternate components.

The main body 112 may be manufactured from a thermoplastic composition or other similar composition. In one embodiment, the main body 112, and other components, such as the top and bottom hard-shells, may be comprised of a polycarbonate composition, which may include adding one or more other substances to the composition such as ABS plastic or hard plastic. The polycarbonate composition may enable the main body or outer shell 112 of the handle-scale 110 to be flexible, while maintaining a generally rigid form.

The handle-scale 110 may include a processor, electronic scale, mechanical scale, or other means for calculating the weight of the hard-sided suitcase 100 when manually lifted and vertically supported by the handle-scale 110. The processor and/or electronic scale may be battery operated and may be turned on and off via the on/off switch or button 120. The handle-scale 110 may include a first digital readout or display 114 that displays whole units of a measurement scale during use, a second digital readout or display 116 that displays a decimal point and partial units of a measurement scale during use, and a third digital readout or display 118 that displays a measurement scale during use, such as kilograms or pounds.

The outer shell or main body 112 of the handle-scale 112 may be configured to protect or substantially protect the digital readouts 114, 116, 118 by withdrawing the digital readouts 114, 116, 118 from an outermost or protruding exterior of the handle-scale. As a result, when a user grips the handle, the user may not touch, substantially touch, or exert any, or substantially any, pressure and/or force upon the face of the digital readouts.

The first end 122 of the main body 112 of the handle-scale 100 may be removably attached, permanently attached, or otherwise affixed to a first mount 126 on the top hard shell 104 of the hard-sided suitcase 100. The second end 124 of the main body 112 of the handle-scale 100 may be removably attached, permanently attached, or otherwise affixed to a second mount 128 on the top hard shell 104 of the hard-sided suitcase 100.

The first end 122 and the second end 124 may each have a slender metal slide protruding from the left and right end of the main body 112, respectfully. During assembly, the left and right metal slides may each slide into a mount on the exterior of the suitcase, such as the first and second mount 126, 128. The left and right metal slides may include one or more surfaces that snap or lock the handle-scale 110 into place with respect the first and second mounts 126, 128. For instance, the left and right metal slides may include one or more openings that snap into corresponding internal surfaces internal to the left and right mounts on the exterior of the suitcase. Additional or alternate means of interconnecting or attaching the first and second ends 122, 124 to the suitcase may be used.

After which, the left and right metal slide may each be movable or retractable within the first and second mount 126, 128 respectfully during use. As a result, the handle-scale 110 may be configured to move between a first and second vertical position. The handle-scale 110 may be biased, pushed, or pulled toward the relaxed or first vertical position, as shown in FIG. 1, by mechanical or other means. For example, the handle-scale 110 and/or the first and second mounts 126, 128 may include one or more weight-release slides, metal hinges, springs, latches, or spring-loaded components pulling or biasing the handle-scale 110 into the first vertical position. Additional, fewer, or alternate biasing components may be used.

The handle-scale 110 may include a switch or button 120. The switch 120 may be an on/off switch that turns the handle-scale 110 or its components, such as a processor or display screen, on and off. Alternatively, the handle-scale 110 may automatically turn on during use, such as when used to lift a suitcase 100. The switch 120 may also include other functionality, such as switching display color or the units in which the luggage is weighed (pounds or kilograms).

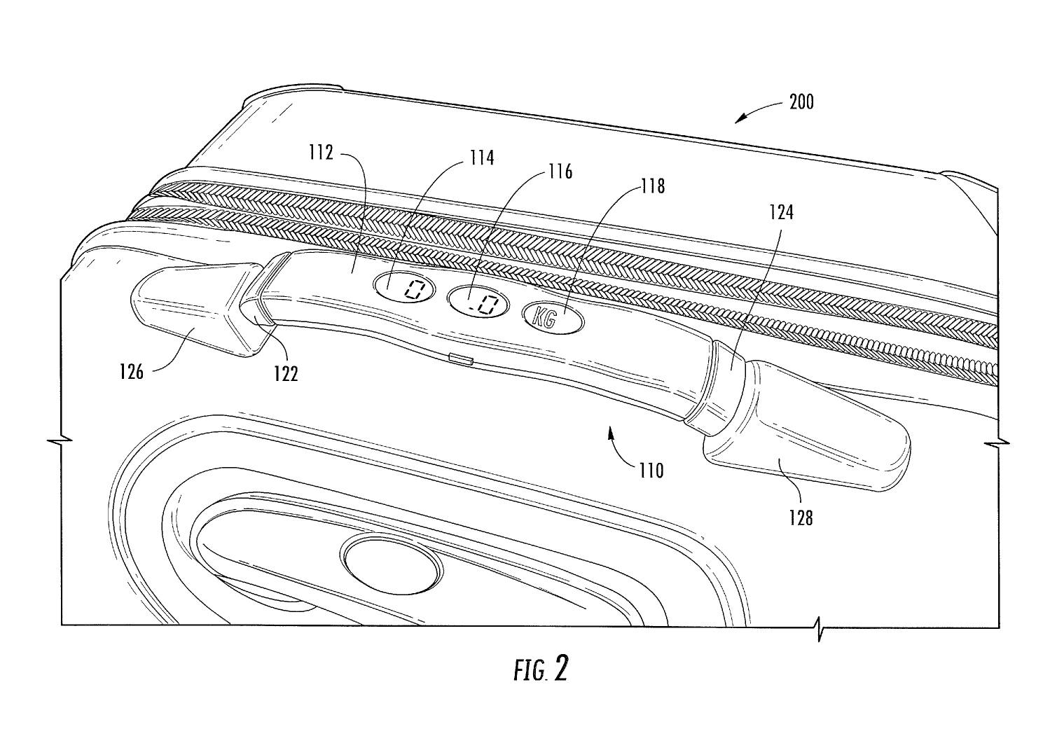

FIG. 2 depicts another view of the exemplary handle-scale in the relaxed or first vertical position 200. As shown, if the handle-scale 110 is turned on in the relaxed or first vertical position 200 before the suitcase is weighed, the handle-scale 110 may display a weight of “0.0 KG” via the first, second, and third digital displays 114, 116, 118 collectively.

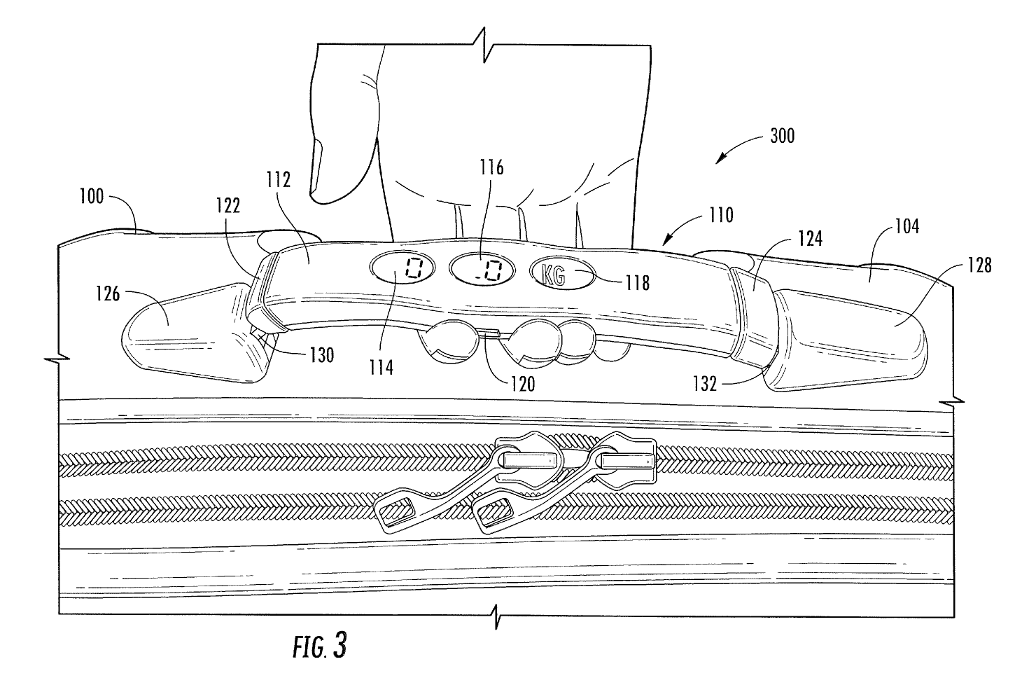

In the relaxed or first vertical position 200, the first end 122 of the main body 112 may rest snuggly against the first mount 126, and the second end 124 of the main body 112 may rest snuggly against the second mount 128. In the relaxed or first vertical position 200, internal slides, hinges, or other pieces that facilitate movement between the first vertical position 200 and the second vertical position (see FIG. 3), may not be exposed or substantially exposed. On the other hand, in the raised or second vertical position, internal slides, hinges, or other pieces may be visible or slightly visible and extend from the first and second end 122, 124 of the main body 112, such as in FIG. 3, discussed below.

FIG. 3 depicts a view of the exemplary handle-scale in a weighing or second vertical position 300. When the hard-shell suitcase 100 is manually lifted via the handle-scale 110, the handle-scale 110 may move upright to a weighing position in which the handle-scale 110 is raised with respect to the hard-shell suitcase 100 and/or the first and second end mounts 126, 128 on the top hard shell 104, as shown in FIG. 3. By manually lifting the hard-shell suitcase 100 via the handle-scale 110, the internal processor or electronic scale within the handle-scale 110 may automatically turn on, and/or calculate a weight of, the hard-shell suitcase 100. Alternatively or additionally, the internal processor or electronic scale may be turned on via a switch or button 120.

The weight calculated may be displayed via one or more digital readouts 114, 116, 118 when the user is still lifting the hard-shell suitcase 100 and/or after the hard-shell suitcase 100 is put back down. For instance, after the weight of the suitcase 100 has been calculated, the background color of the digital display 114, 116, 118 may change or flash, and/or the digital display 114, 116, 118 may display the calculated weight while the suitcase 100 is still being lifted.

Alternatively, the weight calculated may be displayed via the digital readout(s) 114, 116, 118 after the user puts the hard-shell suitcase 100 back down. The processor or electronic scale may calculate and store the weight of the hard-shell suitcase 100 in a memory. Once the user puts the hard-shell suitcase 100 down and the handle-scale 110 returns to the relaxed or first vertical position (such as shown in FIG. 1), the handle-scale 110 may then display the calculated weight, such as the “5.5. KG” shown in FIG. 1. The handle-scale 110 may include a timer such that the calculated weight is automatically displayed for a limited amount of time, such as 5 or 10 seconds. After which, the handle-scale 110 may automatically turn the handle-scale and/or display off.

Additionally, once the handle-scale 110 calculates the weight, an aural indication may be provided. For instance, the handle-scale 110 may provide an alarm or other sound that the weight has been calculated. Alternatively, the handle-scale 110 may provide a digital voice that reads out aurally the calculated weight and units. The handle-scale 110 may include additionally, alternate, or fewer components and features.

As shown in FIG. 3, when the handle-scale 110 is moved vertically into the weighing position 300, left and right metal slides 130, 132 interconnected with the external mounts 126, 128 on the exterior of the suitcase 100, may extend from the external mounts 126, 128, respectively. The left and right metal slides 130, 132 may also be connected with the first end 122 and the second end 124 of the handle-scale 110, respectively, via a metal hinge or other internal component that allows the left and right metal slides 130, 132 to rotate or otherwise move with respect to the longitudinal body 112 of the handle-scale 110. Other types of hinges, slides, and pieces may slide in and out of the body 112 of the handle-scale 110 when the handle-scale 110 is used to lift the suitcase 100.

Also depicted by FIG. 3, the left and right metal slides (and/or respective metal hinges) 130, 132 may rotate or otherwise move into a more vertical position when the handle-scale 110 is moved into the weighing position 300. The left and right metal slides 130, 132 may also be connected to the external mounts 126, 128 on the exterior of the suitcase 100 via a metal hinge or other means that allows the left and right metal slides 130, 132 to rotate or otherwise move with respect to the external mounts 126, 128 during use as well.

In one embodiment, the left and right metal slides 130, 132 may be permanently but rotatably affixed at one end to the first and second mounts 126, 128, respectively, such as via rotatable hinges that are located internally to the first and second mounts 126, 128. The first and second mounts 126, 128 may each have a centrally facing mouth or opening that allows the left and right metal slides 130, 132 to move up and down as their connecting hinge rotates within the first and second mount 126, 128, respectively. The other end of the left and right metal slides 130, 132 may be rotatably, slidably, or otherwise movably affixed to the first and second end 122, 124 of the handle-scale 110. When the handle-scale 110 is moved vertically, the left and right metal slides 130, 132 may rotate upward with respect to the first and second mounts 126, 128 and simultaneously rotate and/or extend from the first and second ends 122, 124 of the handle-scale 110, respectively. Other configurations and moving parts may be used.

### II. Exemplary Suitcase

The handle-scale may be used with various types of luggage or suitcases, as explained above, including hard-sided and soft-sided items. One exemplary suitcase for use with the handle-scale may be a hard-sided suitcase. The hard-sided suitcase may include front, back, side, and top and bottom portions. The suitcase may include two hard-sided shells which may be utilized to form one or more storage compartments for the hard-sided suitcase. Outer portions of the hard-sided shells may form at least a portion of the front, back, sides, top and bottom portions. The inner portions of the hard-sided shells may be lined with various types of fabrics or other similar features and may include one or more pockets, which may be opened and closed through zipper mechanisms or other mechanisms for opening and closing pockets. The two hard-sided shells may be utilized to form a primary compartment. One or more other hard-sided shells may be utilized to form secondary compartments as well.

The shells may be comprised of a thermoplastic composition or other similar composition. In one embodiment, the shells may be comprised of a polycarbonate composition, which may include adding one or more other substances to the composition, such as ABS plastic. The polycarbonate composition may enable the shells to be flexible, while maintaining a generally rigid form. When stressors are applied to the shells, the polycarbonate composition may allow the shells to absorb the impact from the stressors and cause the shells to flex to accommodate the stressors. After the stressors have been removed, the polycarbonate composition may enable the suitcase to return to its original shape.

The hard-sided shells may be connectable to one another through the use of an opening zipper assembly having one or more zippers or other fastening mechanism such as, but not limited to, snap fasteners, buttons, and buckles. Each side of the zipper may include a plurality of metal or plastic teeth, which may be stitched or otherwise attached to corresponding pieces of fabric tape. The fabric tape may be comprised of ballistic nylon or other similar materials. One fabric tape may be stitched or otherwise fastened to an edge of one of the hard-sided shells and the other fabric tape may be fastened to an edge of another hard-sided shell. The zipper may include one or more sliders, which may be configured to hold at least a portion of the plurality of teeth on each side of the zipper mechanism. Once the slider is slid across the plurality of teeth, it may be utilized to connect the edges of the hard-sided shells together, which may form a seal for the storage compartments within the shells.

The suitcase may include one or more handles for carrying, pulling, pushing, and/or lifting the suitcase. The handles may include a rigid, telescoping handle 108 which may have a push button lock. The telescoping handle 108 may be connected to a top portion or other portion of a hard-sided shell so as to allow for easy transportation of the suitcase. The handle may include trolley tubes, which may extend through a portion of the hard-sided shell to which it is attached. This may allow for additional structural support and allow the handle to undergo a greater amount of stress.

In one embodiment, the trolley tubes may be encased within the storage compartment into a protrusion along the backside of the hard-sided shell. The encasing may be performed laying a fabric, plastic, or other material across the trolley tubes so as to ensure the flat surface. Once the trolley tubes are encased, a flat surface may be created across the trolley tubes. This allows one to pack the compartment of the suitcase without having to pack around the trolley tubes, while also ensuring a more uniform compartment space. One may also pack between the trolley tubes. One or more carry-handles 110 may also be included. For example, on a large suitcase, two carry-handles 110 may be provided, one on the top of the suitcase 100 and one on a side thereof.

The suitcase may also be configured to include a plurality of wheels for transporting the suitcase. In one configuration, two wheels may be connected to a bottom portion of a hard-sided shell, preferably along the opposite ends of the bottom of the shell. In another configuration, another set of wheels may be connected to a bottom portion of another hard-sided shell so as to allow for four wheels positioned at the four ends of the bottom of the suitcase.

Any number of wheels and any position for placement of the wheels may be utilized as well. For example, one wheel may be placed on a bottom portion of one hard-sided shell and two wheels may be placed on a bottom portion of another hard-sided shell. Such a positioning allows for greater stability and for easier transportation of the suitcase. In one embodiment, the wheels may be plated with chrome or another similar material. Plating the wheels with chrome or other similar materials may enable the wheels to rotate along a variety of surfaces in a smooth and easy motion by minimizing friction and drag along the surfaces. In another embodiment, the wheels may be hub cap plated. The wheels may be manufactured from rubber, nylon, plastic, metal, or other materials. The wheels may have packed or other types of bearings to facilitate rotation.

The suitcase may be configured to have one or more expandable portions, which may be utilized to expand one or more storage compartments of the suitcase. The expansion portion may comprise a fabric expansion gusset and a polycarbonate composite expansion shell portion. The gusset may be made of ballistic nylon or other similar materials, particularly materials which allow for flexibility. The expansion shell portion may be connected to at least one of the hard-sided shells 102, 104 at an edge of the shell. The carry-handle 110 may be provided at the midpoint of the suitcase, which makes for easier weight distribution and carrying of the suitcase. Such positioning of the handle allows an even-balanced, level lift of the suitcase when an individual decides to transport the suitcase.

### III. Exemplary Method of Weighing Suitcase

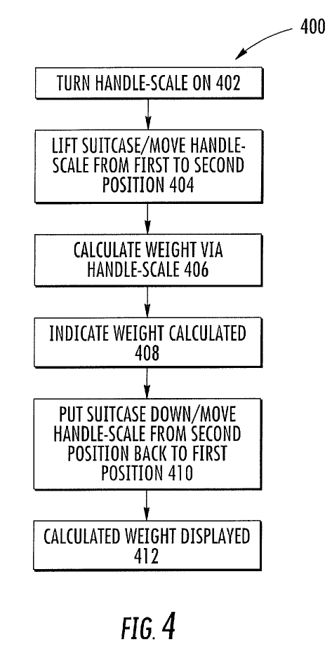

FIG. 4 illustrates an exemplary method of using the handle-scale to calculate the weight of a hard-sided suitcase or other piece of luggage 400. The method 400 may include turning the handle-scale on 402, vertically moving the handle-scale from the first to the second position 404, calculating the weight of the piece of luggage via the handle-scale 406, indicating that the weight has been calculated 408, putting the suitcase down to vertically move the handle-scale from the second position and back to the first position 410, and displaying the calculated weight of the piece of luggage 412. The method may include additional, fewer, or alternate actions.

The method 400 may include turning the handle-scale on 402. For instance, the handle-scale may be turned on by a switch, a button, squeeze or movement activated, touch screen display, or have other means of activation. For instance, moving the handle-scale from the first or relaxed position (as shown in FIG. 1) to the second or weighing position (as shown in FIG. 3), may automatically turn the handle-scale on. The handle-scale may be battery, solar, movement, or vibration powered, or have other means of power. Once the handle-scale 402 is turned on, the digital display may be illuminated in one or more colors.

The method 400 may include moving the handle-scale from the first to the second position 404. For instance, the handle-scale may be moved from the first to the second position when a user lifts up on the handle-scale, whether or not the user lifts the piece of luggage up off the ground. In one aspect, the first position may be a relaxed position that the handle-scale is in when not being lifted, such as shown in FIG. 2. The second position may be a weighing position that results from a user pulling up on the handle-scale and lifting the piece of luggage via the handle-scale, such as shown in FIG. 3.

The handle-scale may have a left metal slide and a right metal slide located at the left end and right end, respectively. The left metal slide may slide into and/or be mounted within the left mount mounted on the top of a hard shell. The right metal slide may slide into and/or be mounted within the right mount also mounted on the top of the hard shell. After being assembled with the left and right end, the left and right metal slides may be slidable or otherwise longitudinally movable with respect to the handle-scale. As an example, when the handle-scale is vertically moved into the weighing position, the left and right metal slides may extend out of the left and right ends of the carry-handle or body of the handle-scale, respectively, allowing the handle-scale to be vertically moved into the weighing position. After which, when the suitcase is put back down, the left and right metal slides may revert or move back into the left and right ends of the carry-handle. respectfully. As a result, the normal position of the handle-scale is the relaxed or rest position, such as shown in FIG. 1.

Alternatively or additionally, when the handle-scale is vertically moved into the weighing position, the left and right metal slides may extend out of the left and right mounts, respectively, allowing the handle-scale to be vertically moved into the weighing position. After which, when the suitcase is put back down, the left and right metal slides may revert or move back into the left and right mounts, respectfully. The handle-scale and/or the left and right mounts may include internal springs and/or metal hinges biasing or pulling the left and right metal slides back toward the relaxed or rest position of the handle-scale.

The method 400 may include calculating the weight of the piece of luggage via the handle-scale 406. Once the handle-scale is supporting the weight of the piece of luggage and in the second position, the handle-scale may calculate the weight of the piece of luggage. For instance, the handle-scale may include a processor or electronic scale, or mechanical scale, to electronically or mechanically calculate the weight being supported by the two ends of the handle-scale. For instance, the movement and/or position of the left and right metal slides may be measured during use and converted into a calculated weight. Other scales may be used.

While the weight is being calculated, the display may or may not be illuminated. After the weight is calculated, the handle-scale may provide an aural or visual indication to the user that the weight has been calculated and the piece of luggage may be placed back down. For instance, the weight may be displayed as indication, the background color of the display may change, the color of the weight displayed may change, a beeper may sound, a voice may state the calculated weight, and/or an indicator light may illuminate.

The method 400 may include indicating that the weight has been calculated 408. As noted above, an aural or visual indication may be provided. In one embodiment, after the processor or electronic scale weighs the piece of luggage, it may lock in the weight calculated, such as in a memory, register, or other device. After the weight calculated is saved, the display screen may change colors, such as from blue to red. For example, either the background color of the display and/or the color of the numerals displayed may be changed or flashed.

The method 400 may include putting the piece of luggage down to allow the handle-scale to retract from the first to the second position 410. Once the piece of luggage is put down, the handle-scale may return to the relaxed position, such as shown in FIG. 1, from the weighing position, such as shown in FIG. 3. The handle-scale may be biased toward to the relaxed position by one or more springs or metal hinges located in the left and right mounts on the exterior of the suitcase. Other means for returning the handle-scale to the relaxed position from the weighing position may be provided, such as various springs, hinges, latch hinges, spring loaded hinges, and other biasing components. Putting the piece of luggage down may facilitate reading the weight displayed, which may be displayed for a limited period of time, such as several seconds.

The method 400 may include reading and/or displaying the calculated weight of the piece of luggage 412. After the weight is calculated, and/or after the piece of luggage is put down by a user, the calculated weight of the piece of luggage may be displayed by the digital readouts of the handle-scale. For instance, FIG. 1 depicts displaying a weight of “5.5 KG.” Alternatively, the calculated weight may also be displayed while the handle-scale remains in the weighing position (shown in FIG. 3).

The integrated handle-scale of the present embodiments may be integrated with a light weight, but flexible and impact-absorbing hard-shell. The integrated handle-scale may include a touch screen and voice features. The integrated handle-scale may easily convert measuring units from kilograms to pounds, and vice versa. The integrated handle-scale may include cushioned or other ergonomic handle-grips. The integrated handle-scale may be used with a suitcase that features a biometric locking system. Alternatively, the integrated handle-scale may include a biometric locking functionality, such as a finger print reader in the body or main frame of the handle-scale. As an example, a swipe of a finger over a finger print reader may activate the electronic scale of the integrated handle-scale and allow one to weigh the suitcase using the integrated handle-scale. The finger print reader located within the integrated handle-scale may also open one or more compartments of the suitcase.

The integrated handle-scale may calculate the weight of an attached suitcase during use. Once the weight is completely calculated, the integrated handle-scale may alert the user and/or display the results on a display screen or touch screen. The display may change color from blue to red when the weight of the suitcase has been determined. The handle-scale may include a 60-second auto shut-off that turns off the handle-scale after 60 seconds to save battery power and extend the life of the battery.

The arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure not be limited to the particular arrangement(s) disclosed as the best mode contemplated for carrying out this invention, but that the invention will include all embodiments and arrangements falling within the scope of the appended claims.

What is claimed is:

1. A handle-scale for calculating a weight of a suitcase, the handle-scale comprising:
a hard outer shell configured as a carry-handle of the suitcase, the carry-handle having weight-release slides on a left end and a right end of the carry-handle attaching the carry-handle to the suitcase;
scale functionally enclosed within the hard outer shell that is configured as the carry-handle, the scale functionally configured to calculate a weight of the suitcase when the suitcase is manually lifted by the carry-handle; and
a digital display embedded within the carry-handle that is configured to display a calculated weight of the suitcase, the digital display configured to provide a visual indication or an aural indication indicating that the weight of the suitcase has been calculated when manually lifted by the carry-handle during use.

2. The handle-scale for calculating a weight of a suitcase of claim 1, wherein the visual indication provided indicating that the weight of the suitcase has been calculated when manually lifted by the carry-handle during use involves the digital display changing a background color or a color of the weight displayed after the weight of the suitcase has been calculated.

3. The handle-scale for calculating a weight of a suitcase of claim 1, wherein the digital display includes a touch screen display that is configured to change a manner in which the calculated weight is being displayed on the digital display.

4. The handle-scale for calculating a weight of a suitcase of claim 1, wherein the hard outer shell is configured such that the digital display separately displays (1) a measurement scale in which the calculated units are being calculated via the processor, (2) a whole units of the calculated weight within the measurement scale, and (3) a partial units of the calculated weight within the measurement scale.

5. The handle-scale for calculating a weight of a suitcase of claim 4, wherein the handle-scale is battery operated and includes an on/off switch configured to turn the handle-scale on and off.

6. The handle-scale for calculating a weight of a suitcase of claim 5, wherein the outer hard shell is manufactured from a hard plastic material.

7. A handle-scale for calculating a weight of a suitcase, the handle-scale comprising:
a handle-scale configured to manually lift a suitcase, the handle-scale configured to be movable vertically between a first vertical position and a second vertical position with respect to the suitcase during use, the first vertical position being a relaxed position of the handle-scale that the handle-scale is in when the handle-scale is not weighing the suitcase, and the second vertical position being a weighing position of the handle-scale that the handle-scale is in when the handle-scale is supporting the suitcase vertically and weighing the suitcase;
a processor embedded within the handle-scale configured to calculate a weight of the suitcase when the suitcase is manually lifted via the handle-scale and the handle-scale moves vertically from the first vertical position to the second vertical position; and
a digital readout display on an outward face of the handle-scale for displaying a digital readout of the calculated weight of the suitcase that is calculated when the suitcase is manually lifted via the handle-scale.

8. The handle-scale of claim 7, wherein the handle-scale includes an outer shell configured to protect the digital readout by withdrawing the digital readout from an exterior of the handle-scale such that when a user grips the handle, a palm of the user does not exert substantial pressure directly onto a face of the digital readout.

9. The handle-scale of claim 7, wherein the handle-scale includes an outer shell having an undulating outer exterior to facilitate gripping the handle-scale and manually lifting of the suitcase via the handle-scale.

10. The handle-scale of claim 7, wherein the outer shell of the handle-scale is manufactured from a polycarbonate composite, and the suitcase is a hard-shell suitcase.

11. A hard-shell suitcase having a handle-scale, the hard-shell suitcase comprising:
a bottom hard-shell;
a zipper assembly interconnected with the bottom hard-shell;
a top hard-shell interconnected with the zipper assembly such that the top hard-shell may be opened up from the bottom hard-shell by operation of the zipper assembly;
a left mount and a right mount affixed to the top hard-shell;
the handle-scale having a left end and a right end, the left end being interconnected with the left mount and the right end being interconnected with the right mount such that the hard-shell suitcase may be manually lifted via the handle-scale, the handle-scale being configured to move vertically between a relaxed position during non-use and a weighing position during use;
a processor embedded within the handle-scale configured to calculate a weight of the hard-shell suitcase when the hard-shell suitcase is manually lifted via the handle-scale; and
a digital readout display on an outward face of the handle-scale configured to display a digital readout of the calculated weight of the hard-shell suitcase that is calculated when the hard-shell suitcase is manually lifted via the handle-scale.

12. The hard-shell suitcase having a handle-scale of claim 11, wherein the handle-scale includes an outer shell configured to protect the digital readout by withdrawing the digital readout from an exterior of the handle-scale such that when a user grips the handle, a palm of the user does not substantially touch or otherwise exert pressure onto a face of the digital readout.

12. The hard-shell suitcase having a handle-scale of claim 11, wherein the handle-scale includes an outer shell having an undulating outer exterior to facilitate gripping the handle-scale and manually lifting of the hard-shell suitcase via the handle-scale.

13. The hard-shell suitcase having a handle-scale of claim 11, wherein the handle-scale includes an outer shell configured to separately display units and a weight amount of the calculated weight of the hard-shell suitcase.

14. The hard-shell suitcase having a handle-scale of claim 11, wherein the handle-scale is configured to provide a visual indication or an aural indication that the weight of the hard-shell suitcase has been calculated.

15. A piece of luggage having a handle-scale, the hard-shell suitcase comprising:
a handle-scale interconnected with the piece of luggage such that the piece of luggage may be manually lifted via the handle-scale, the handle-scale being vertically movable between a relaxed position and a weighing position with respect to the piece of luggage, the handle-scale being configured to vertically revert to the relaxed position during non-use and move vertically to the weighing position when the handle-scale is being used to lift the piece of luggage;
an electronic scale embedded within the handle-scale configured to calculate a weight of the piece of luggage when the piece of luggage is manually lifted via the handle-scale; and
a digital readout display on an outward face of the handle-scale for displaying a digital readout of the calculated weight of the piece of luggage that is calculated when the piece of luggage is manually lifted via the handle-scale.

16. The piece of luggage having a handle-scale of claim 15, wherein the handle-scale includes an outer shell configured to protect the digital readout by withdrawing the digital readout from an exterior of the handle-scale such that when a user grips the handle, the user does not substantially touch or exert pressure onto a face on the digital readout.

17. The piece of luggage having a handle-scale of claim 15, wherein the handle-scale includes an outer shell having an undulating outer exterior to facilitate gripping the handle-scale and manually lifting of the piece of luggage suitcase via the handle-scale.

18. The piece of luggage having a handle-scale of claim 15, wherein the handle-scale includes an outer shell configured to separately display units and a weight amount of the calculated weight of the piece of luggage.

19. The piece of luggage having a handle-scale of claim 15, wherein the handle-scale is includes metal hinges on a left end and a right end configured to automatically move the handle-scale downward vertically and return the handle-scale to the relaxed position from the weighing position when the piece of luggage is set back down during use.

20. The piece of luggage having a handle-scale of claim 15, wherein the handle-scale is configured to provide a visual or an aural indication that the weight of the piece of luggage has been calculated during use.
